(19) United States
(12) Patent Application Publication
(10) Pub. No.: US 2005/0165692 A1
(43) Pub. Date: Jul. 28, 2005

(54) Method and a system for tracking distribution chains of digital resources and services

(76) Inventor: Pasi Tyrvainen, Pyhitty (FI)

Correspondence Address: YOUNG & THOMPSON, 745 SOUTH 23RD STREET, 2ND FLOOR, ARLINGTON, VA, 22202, US

(21) Appl. No.: 10/503,635

(22) PCT Filed: Feb. 4, 2003
(86) PCT No.: PCT/FI03/00087

(30) Foreign Application Priority Data
Feb. 5, 2002 (FI) 20020224

(51) Int. Cl. G06F 17/60

(52) U.S. Cl. 705/59

(57) ABSTRACT

The invention is related to management of the use of digital data. Especially this invention is related to tracking the operation of delivery channels of various digital products by means of licensing. Data collected by tracking can be used as a part of a product delivery system and the revenue logic of the various parties related to it. The aim is achieved in such a way that the data about the first party and other necessary data about the prior lifecycle of the product copy is delivered along with the product delivered from a party to another party. In order to gain full rights to use the product, the second party activates a license request unit, which in addition to the registration data of the second party passes also the previously mentioned data to the publisher of the product.

The invention is related to management of the use of digital data. Especially the invention is related to tracking the operation of delivery channels of various digital products by means of licensing. Data collected by tracking can be used as a part of a product delivery system and the revenue logic of the various parties related to it.

Delivery of digital data and services differs from-the logistics of sales and delivery of physical products. A client can order a digital product straight from the manufacturer or the publisher without any help from a geographically close locating salesman. Products can also be delivered via data networks to geographically distant locations. Identical copies can be produced from the products without high production costs. The emergence of unpaid and illegal product copies created by the easy transferability and pirating of the products is attempted to make prevented by integrating to them licensing means, which limit unpaid use of the product.

In this application a resource refers to a physical implementation unit or a system in a broad sense, which can be such as computer hardware or software, software functionality or a set of articles of a database. A resource thus implements a specific service, which can be such as an operation implemented by computer hardware or software or a functionality of a program. A digital resource refers to a resource, which does not contain a physical equipment as such, but presupposes and requires for functioning the existence of a specific standard equipment, such as existence of a PC equipment and MS Windows® operating system. A web service refers here to functionality provided by resources accessed through networks, such as Internet, that are used through standardized software interfaces, for example, using a browser, via http and TCP/IP protocols. Use of both of these products is managed by using licenses, which define the access rights to a service provided by a specific resource. A license can be a plain textual agreement attached to a resource or a digital identifier controlled by a license control system, by aid of which the license control system controls the use of a license. Here a license refers, by default, to a digital license.

It is typical for the prior art implementations to use multiple license types. A digital resource targeted to a PC environment is usually delivered after a purchase on a CD-ROM medium. A license control system can, based on digital licenses, control also the properties of the product used. As an examples of known solutions are the patent PCT/US01/18762 “Method and system for limiting the use of user-specific software features” and standard-like definitions Open Digital Rights Language (www.odrl.org) and eXtensible rights Markup Language (XrML) (www.xrml.org), which define information contents of rights definitions for digital resources, interpretable as licenses, including definitions for constraints of use, entity identification, and other needed features.

It is often possible to transfer a free demonstration version or a sponsored version of a digital resource from an Internet server to a personal computer. The functionality of a demonstration version is typically restricted for example to a subset of a program's functionalities, to a limited validity period or by other means. A sponsored version functions usually the same way as the full product, but presents advertisements to the user. Compulsory registering is often used with a sponsored version, i.e., user identification data are transmitted to the publisher of the product. According to registering the publisher can verify the user count of a product to sponsors and get compensation for distributing advertisements. Here registering is interpreted as a sub-domain of licensing.

Publisher of digital products refers here to the role or organization, whose role is to produce copies of digital resources, and to take care of organizing the marketing and sales activity of those by itself or over other organizations. The publisher can promote distribution of the products without salesmen and campaigns, directly via customers. A user of a digital product can be encouraged to distribute demonstration versions of a product to other users, who possibly order a license granting rights to the use of a full-blown product from the publisher. Free Internet services, such as news services, can also include a possibility to request the publisher to send a copy of the news to a friend, whereupon the publisher gains the information of a potential customer.

It is typical for the known solutions that the information systems of a sales transaction do not register the salesman initiating the sales process. For example, a salesman of CAD design systems intended for professional use can consult a customer for several days in order to compose a collection of software and digital resources matching the customer's needs, even install a version of it with a demonstration license to the customer equipment, and be left without the selling commission as the customer orders the license granting rights to use the product through the Internet, because the order entry system does not register the sales channel. A salesman is not either willing to give his list of potential customers to the publisher in advance as pre-sales records because this way he would give up his valuable information for free. On the other hand the publisher is not either willing to pay sales commissions for purchases of all the customers, which are in the list of potential customers of one or even more salesmen, unless the salesman has convincingly been selling to close the deal. Also the motivation of the software users to distribute the product to other potential buyers would be higher, if it were possible to get compensation for the sales like the provision of the salesmen.

The aim of the invention is a system, using which the copies of digital resources can be tracked in such a way that the delivery channel of a product and other information needed related to the lifecycle of a product copy are available for the publisher. Particularly the aim is a method and a system, using which the participation of each party of a sales channel to an individual sales action can be verified, commissions of the parties be determined and by this means to increase the motivation of salesmen and the sales actions.

The aim is achieved so that the data about a first party of the delivery channel and other necessary data about the prior lifecycle of a product copy or a digital resource are delivered along with the product delivered from the first party to another, second party. In order to gain full rights to use the product or the resource, the second party activates a license request unit, which in addition to the registration data of the second party passes also the previously mentioned data to a license creation unit of the publisher of the product or the resource. The license creation unit of the publisher records the received data and activates the actions needed for paying the commission. In addition, the license creation unit returns to the second party an execution license he requires as well as a product version intended for further distribution, or a part of it, such as a demonstration license, which contains also the identification data of the second party. The entirety is described in detail in the description.

The invention is characterized in that what is stated in the characterizing parts of the independent claims. Advantageous embodiments of the invention are described in the dependent claims and in the description.

According to an advantageous embodiment of the invention an execution license is requested for using a digital resource. As a response to the request of an execution license a license request unit is activated. The license request unit has access to license templates and data included in those. Typically the license request unit creates a license request by combining data of a license template with customer data needed, these including for example data about payment/purchase of the license, data about equipment the resource is to be used and a history data of the resource. Besides the history data contained in a license template, there may be some additional history data contained in some other licenses, such as execution licenses, demonstration licenses or obsolete licenses. The history data usually includes data about previous possessions of the digital resource and data about lifecycle of the digital resource. The history data is then transmitted in a form of a license request to the license creation unit. The license creation unit forwards the history data to information systems monitoring delivery channels, adds the history data to customer-specific license templates sent to the customer, and transmits the history data with the execution license generated by a license creation unit. The license creation unit is typically controlled and maintained by the publisher of the digital resource. Advantageously the publisher has all the time the knowledge of used distribution channels, and data of the lifecycles of the digital resources. According to an advantageous embodiment of the invention the use of digital resources can be tracked even when those are delivered through a complicated distributing net, including delivery channels of many distributors, sub-distributors and/or customers acting as distributors.

The salesman gains benefit from the equipment and method according to this invention in the form of commissions, when the results of sales effort are recorded to the right persons, and the data about potential customers does not have to be given to the publisher prior to the sales transaction. The publisher gains benefit from the arrangement by getting exact data about the operation of the sales channels as well as by getting a clear incentive method for digital products, for which it was not possible earlier. The publisher can also analyze its sales channels, for example track the long-term effect of campaigns by attaching a campaign identifier to the demonstration products distributed in a campaign or a fair. The results can be identified from the data produced by the license creation unit with the aid of a campaign identifier. The publisher can also encourage the customers to sell the product further for example by promising extra licenses for the sales. Also the customers gain benefit from this. The customers gain better support from the salesmen, which know that they are to be rewarded for their efforts.

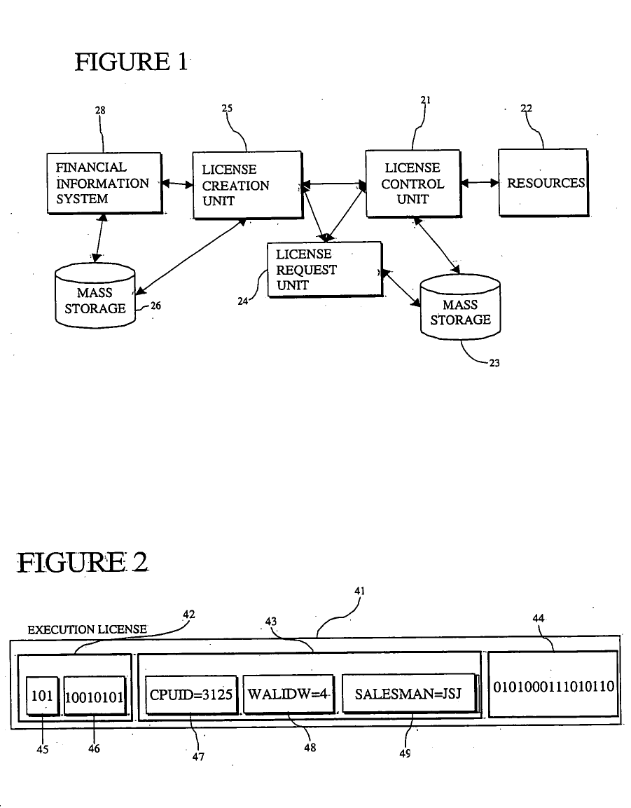

Next the invention is described in greater detail with the aid of accompanying drawings, in which
FIG. 1 illustrates a unit structure according to an advantageous embodiment of the present invention,

FIG. 2 illustrates a structure of a license according to an advantageous embodiment of the present invention,

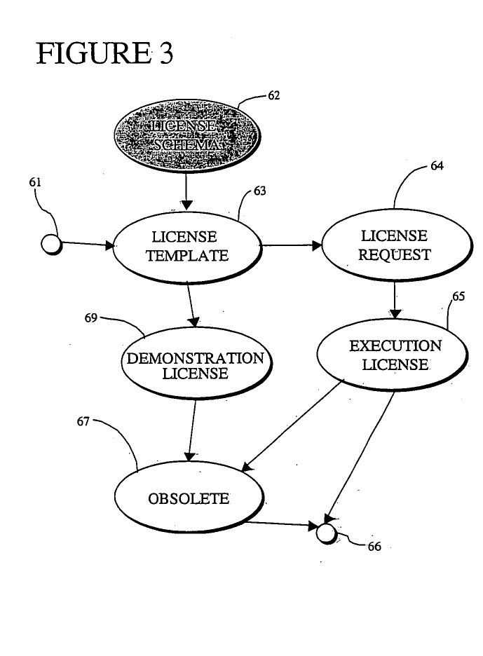

FIG. 3 illustrates states of a license during the phases of its lifecycle,

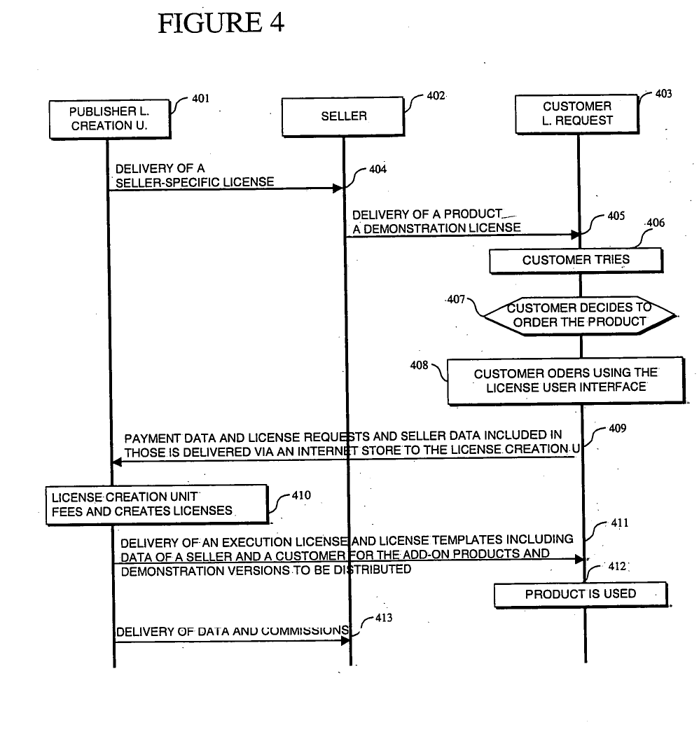

FIG. 4 illustrates interactions in between the units according to an advantageous embodiment of the present invention, and

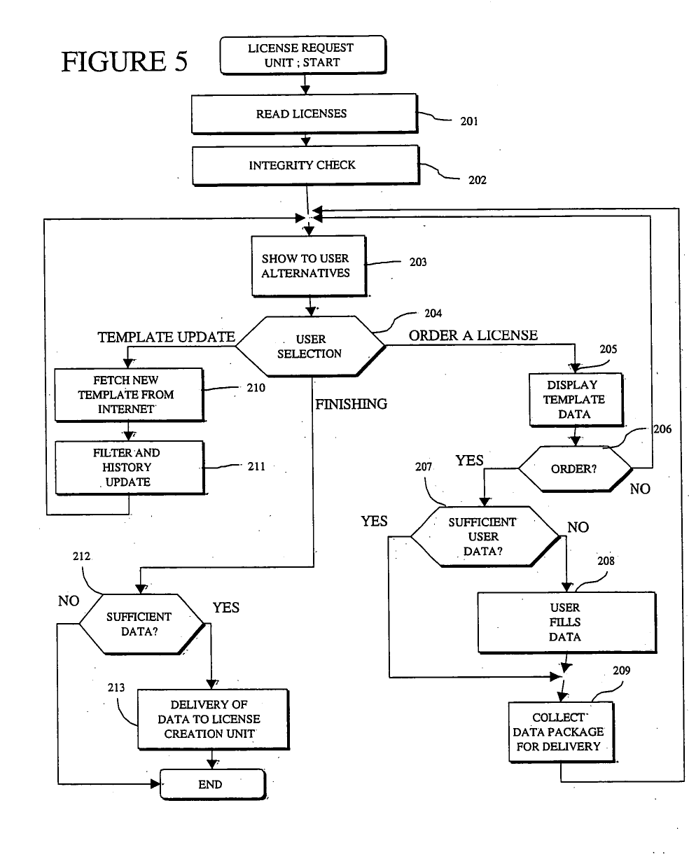

FIG. 5 illustrates operation of a license request unit according to an advantageous embodiment of the present invention.

FIG. 1 illustrates equipment according to an advantageous embodiment of the present invention, which components can be distributed along a set of computers connected with data communication connections. According to this advantageous embodiment the parts of a system include a license control unit 21, which controls the use of the digital resources 22, by using the execution licenses stored to the mass storage 23, and a license request unit 24, by using which a license template is modified and a request for a new execution license is send to the license creation unit 25 located at the publishers equipment. In addition to the license creation unit 25 the components of the publisher of the product include typically a data storage 26 associated with it, which data storage contains the track record of the licenses as well as some kind of interface to the financial systems 28, using which the transfer of sales commissions is taken care of. Payment of the licenses can be taken care of based on the data gained by the license creation unit 25 from the license request unit 24, through the financial systems 28 or using a separate payment system, but it has been dropped out from the figure representing this advantageous embodiment for the sake of simplicity.

FIG. 2 illustrates the structure of a license of this advantageous embodiment. An execution license 41 granting the rights to use a resource comprises a header 42, a set of attributes with their values 43 and integrity data 44. The header comprises license schema's version 45 and a seed for a cryptography key 46. The attribute data comprises attributes and their values, such as the processor identifier of the equipment used 47, validity period of the license 48 and an identifier of the seller of the license 49. The integrity data 44 contains data necessary for verifying the integrity of the data structure of the license, such as a checksum, a signature, a watermark or alike. From the viewpoint of the present invention the point is that among the attributes contained in the licenses, such as license templates, execution licenses, demonstration licenses or other kind of licenses, there exists so called history data, which typically includes the identification data of the previous owner or owners of licenses for the product/resource copy as well as other necessary data about the life-cycle of the resource copy, such as campaign identifiers. The history data is typically contained in attributes of license templates, license requests and execution licenses. With the history data contained in attributes of the licenses delivery channels, distributors and use of the resources can be tracked easily and unambiguously. According to one advantageous embodiment the add-on products, which are only usable with a certain base product, have also access to the history data of their base product.

FIG. 3 illustrates as a state chart variants of digital licenses, their states and lifecycles. In this application the term license is used to describe in general all license types and states, such as license templates, demonstration licenses, full-/limited licenses, execution licenses, etc. A license template 63 and a license request 64 are licenses, which do not grant rights to use a product like an execution license 65 does. A license template 63 contains the attribute data needed for description of the product, such as, information about the product, about the validity period of the license, and about the functionality allowed by the license. By constraining the use of the same resource in different ways license templates 63 matching multiple products can be made out of the same resource. A license schema 62 defines, for the attributes used in license templates and licenses, the attribute names, value domains, and their interpretation. A demonstration product is delivered with a demonstration license 69, which grants rights to limited use of the resource. With a demonstration product also license templates are supplied, from which the license request unit can produce a license request 64 by modifying attributes of a license template. In addition to the data of the license template, the license request 64 contains a processor identifier (47, in FIG. 2) and other data of the target environment of the license, using which the license can be bound, for example, to be used only in a single device, if necessary. In addition there is attached to the license request 64 an identifier of the salesman (49, in FIG. 2) and other lifecycle data of the product copy or the resource, which are delivered along with the license request from the license request unit (24, in FIG. 1) to the license creation unit (25, in FIG. 1) according to the explanations of the following figures. A license creation unit creates an execution license 65 by adding into the license request necessary attribute data and necessary certificates. The license control unit allows use of a resource based on the data of an execution license, until a license gets obsolete 67 or is removed 66.

According to a second advantageous embodiment of the present invention, instead of the concrete data structure of an execution license 41 illustrated in FIG. 2, there may be used for transmitting data, data structures of some public definition, such as ODRL definition or the XrML definition, for example in their XML representation format. These definitions are applicable, after adding extensions needed to support the method and the system according to the present invention, to presentation of a license data content, even though these definitions lack the lifecycle approach required for the function of the present invention. They have, though, means to represent various constraints of use, and the data integrity assurance techniques used with them can be applied also in the first advantageous embodiment, for example W3C XML Signature, W3C XML Encryption and X509 and SPKI-based signature techniques. A license template according to an advantageous embodiment using the ODRL data representation is represented in a simplified form as follows:

<?xml version=“1.0” encoding=“UTF-8”?>
<o-ex:rights xmlns:o-ex=“http://odrl.net/1.0/ODRL-EX”

xmlns:lc=“http://lifecycle...” ...>

<o-ex:offer>

<o-ex:asset>

<o-ex:context>

<o-dd:uid lc:idscheme=“prodnum”>prod12</o-dd:uid>
<lc:parentprod lc:idscheme=“prodnum”>prod345

</lc:parentprod>

<o-dd:name>My digital resource product</o-dd:name>

</o-ex:context>

</o-ex:asset>
<o-ex:party> ... </o-ex:party>
<o-ex:permission> ... <o-ex:permission>
<lc:history>

<o-ex:context>

<o-dd:uid o-ddidscheme=“URI”>http://p...</o-dd:uid>
<o-dd:name>John Smith Junior</o-dd:name>

</o-ex:context>
<o-ex:context> ... </o-ex:context>

</lc:history>

</o-ex:offer>

<o-ex:rights>

I.e., the rights definition according to the ODRL is extended with name space ‘lc’ in which the elements needed for the history data are defined. The product definition of the offer element (offer) can be taken care of by existing means by using context definitions within an asset element. In this example a new ‘prodnum’ schema has been added as an idschema, but this kind of addition is not obligatory, but for example the URI schema can be used. The product definition is extended with a parentprod element of the lc name space, which defines to an add-on product its base product according to the explanation of FIG. 5. The party definitions (party) and rights definitions (permission) define the creator of the offer and the properties of the product in ordinary way. In addition to them a history element of the lc name space has been added here, which history element contains context definitions, by which the previous delivery chain members of the product copy are defined. Here the first one has been identified with an URI identifier and his name (John Smith Junior) has been represented. In addition, there can be used role definitions and other parts of context definition in the ordinary way or with extensions. In this example there are two of these context definitions, i.e., the salesman JSJ has already sold the product to the customer defined in the second context element of the history element. This license template is thus a license marked according to the customer in question, which he can distribute to other potential users, whose purchases can be rewarded both to the customer in question and to the original salesman.

FIG. 4 illustrates basic functioning of an advantageous embodiment in a situation, in which the publisher of a resource 401 wants to distribute resources via salesmen 402 to customers 403. In this advantageous embodiment the publisher delivers the product to the salesmen for example on CD-ROM medium and attaches with it demonstration licenses 404. The licenses can be delivered along with the product or the resource, or licenses can be transmitted separately, as an own entity form permitting a use of the digital resource. In this advantageous embodiment the publisher has included the identification data of the salesman both to the demonstration licenses and to the license templates. The identification data can also be delivered within the product, for example by attaching to it a digital watermark, which contains the necessary data or acts as an index to the data in publisher's database. According to yet another advantageous embodiment the seller can himself add the data with a limited license creation unit, with which only a pre-limited part of the license data can be modified. The salesman delivers the product and the demonstration licenses and license templates marked with the identifier of the salesman to the customer 405. When a customer tries out the limited product 406 and decides to order the product 407, he can by using the user interface of the license request unit, choose the license template matching the product or resource he wants and fill an order 409 for requesting an execution license for using the chosen product or digital resource. The operation of the license request unit is described in greater detail in FIG. 5. Customer actions related with payments have been left out from here due to simplicity. The license creation unit performs the necessary book keeping 410 and takes care of delivering the data to the financial administration systems. The license creation unit may verify a data of a received license request with a data of the corresponding license template delivered in phase 404. The verifying reduces the need of encrypting used license templates due to integrity and security reasons. The license creation unit generates the execution licenses, which are used by the license control unit delivered either with the product or with the execution license transmitted to the user for controlling the use of the resource. It also generates new demonstration licenses and license templates, which contain history data about the resource, data about the salesman and the customer, and delivers them to the customer 411. These are used further in cases, such as while using the product 412 the customer delivers a demonstration version of the product to another potential customer, whose purchase of licenses generates revenue, from which provisions possibly are rewarded to the first customer and to the salesman. License creation unit's data about sold products is delivered through the financial administration systems to the salesman, who can also be rewarded using a sales provision 413. Also the distribution channels, distributors and lifecycles of the licenses and resources can be tracked with the aid of the data recorded by the maintainer of the license creation unit.

FIG. 5 illustrates the operation of a license request unit according to an advantageous embodiment of the present invention. First the unit reads the licenses and license templates 201 in its possession and verifies, if the licenses have maintained integrity, their validity etc. 202. The user sees information about valid licenses from his user interface 203 as well as a list of products that can be ordered, based on license templates in the first advantageous embodiment, based on offers in the ODRL-based model. The user can choose among alternative actions 204. He can have a closer look at the data of an offer or a template 205 and place an order for a new license 206. If the license request unit does not have sufficient information about the user 207, it requests for that data 208 and collects the data to be delivered 209. In this phase the license request unit typically attaches to the license template to be ordered: user's payment data, equipment identifiers needed for the execution license, as well as the history data needed according to the present invention, which include from the license template the salesman identifier and other history data; from the demonstration license of the same product the salesman identifier and history data; from possible previous execution licenses of the same product the salesman identifiers and history data; as well as for add-on products, from its base product the salesman identifier and history data. This ensures that the salesman data of an obsolete license does not get lost or in case, for example, a spell-checker of a word processor, that the sales data of the word processor software does not get lost. However this requires, that the license of an add-on products (spell-checker) includes information about the base product (word processor). In the alternatives block 204 the user can also request for an update for product/license template offerings. This is possible by fetching new license templates 210 from publisher's Internet server using a network connection. The license request unit may fetch any history data concerning the digital resource, data of a current license template, data of a demonstration license of the digital resource, data of a former execution license of the digital resource and/or data of a base product of an add-on product. However, unnecessary ones need to be filtered out 211, such as, templates for such add-on products, for which base product the user does not have a license, as well as license templates covered by already existing licenses. At the same phase 211 some of the history data can already be pre-filled to the license templates fetched, such as, the salesman identifier of the first product delivered to the customer, the identifier of the salesman of the base product to the license template to an add-on product and so forth. When the user is ready, it is checked 212 if all necessary information to be sent to the license creation unit exists and the data is delivered 213.

In yet another advantageous embodiment the products, or usable resources are net services. In this case the method and the system follow mainly the previous embodiment. However, there is no need to transfer the product physically, but transferring the product from the seller to the customer refers to transferring the license and other information needed for using the net service. The same resource can also be available for multiple customers by multiple execution licenses at the same time. Thus it is not applicable to add salesman identifier and other similar data to the resource itself with watermark technique because that would require creation of an own product copy for each seller, but rather this data is stored in licenses, eventually granting rights to use the resource. In this advantageous embodiment all the units in FIG. 1 can be located on the same www server or can be distributed to multiple equipment, for example, by keeping the financial system 28 and mass storage 26 and possibly the license creation unit 25 in separate systems controlled and maintained by the publisher.

The above mention embodiments are applicable also then, when a customer acts as a salesman of the product to another customer. Also in this embodiment the customer acting in the role of a salesman usually receives from the publisher license templates and demonstration licenses that contain his identification data or a digital resource with his watermark. As a second alternative, the abovementioned embodiment, in which the one acting in the role of a salesman can do limited modifications to a license template with a limited license creation unit, is also possible. The limited license creation unit allows only limited modifying of license templates. This modifying can be limited to only certain range of values or certain attributes, which are previously defined.

In one advantageous embodiment a license control unit and a license request unit manage only registration data of a use of a product i.e., do not charge fees from the customers from execution licenses. Also in this embodiment the publisher can reward the customer acting in the role of a salesman for the sales effort performed either monetarily or for example, with extra licenses.

As a consequence of the advance of the data security technology, part of the functionality of a license creation unit 25 according to the first advantageous embodiment can be integrated into a single entity with the license control unit 21 and license request unit 24 and also be repositioned as a part of the product. This embodiment is practical especially when applying data definitions like ODRL. With respect to this advantageous embodiment of the present invention the license creation unit contains both an integrated part as a part of the product, which produces an execution license from a license template, and a part communicating with and delivering data to the information systems of the publisher of the product, to which the data about product lifecycle needs to be delivered when registering or taking a new license in use. In this embodiment data delivered to the license creation unit is thus interpreted as data delivered to the publisher.

1-20. (canceled)

21. A method for tracking delivery channels of a digital resource and use of those by means of licensing, the method comprising steps of:
requesting an execution license for using a digital resource, and as a response to the request, activating a license request unit for creating a license request including data of a license template of the digital resource,
modifying attributes of the license request by the activated license request unit, attributes including history data about previous possessions of the digital resource and about a lifecycle of the digital resource, and
transmitting the modified license request to a license creation unit for generating the requested execution license for controlling the use of the digital resource by a license control unit.

22. A method according to claim 21, wherein after transmitting the modified license request to a license creation unit, the method including steps of:
returning a copy template for asking an identification of an execution environment,
adding an identification of a chosen execution environment to the copy template using a license request unit in order to create a second license request, and
transmitting the second license request to a chosen license creation unit for generating the requested execution license for controlling the use of the digital resource by a license control unit.

23. A method according to claim 21, including steps of:
returning a copy template with the execution license for enabling requesting an execution license for a chosen second execution environment,
adding an identification of the chosen second execution environment to the copy template using a license request unit in order to create a second license request, and
transmitting the second license request to a chosen license creation unit for generating the second requested execution license.

24. A method according to claim 21, comprising steps of generating, in the license creation unit, a new demonstration license and a license template including data about present and previous possessions of the digital resource and transmitting those along with the requested execution license.

25. A method according to claim 24, comprising a step of forwarding the new demonstration license and the license template further for enabling requesting of an execution license for using a certain digital resource.

26. A method according to claim 21, wherein the attributes of the license request include data for identifying the equipment requested for using the digital resource and the history data including former possessions of the digital resource.

27. A method according to claim 26, comprising a step of fetching by the license request unit the history data comprising data of a current license template, and/or data of a demonstration license of the digital resource, and/or data of a former execution license of the digital resource, and/or data of a base product of an add-on product.

28. A method according to claim 21, wherein the history data of used distribution channels and lifecycle of the digital resource are recorded and/or forwarded by a license creation unit, which is controlled by a publisher of the digital resource.

29. A method according to claim 21, wherein a license and the history data of the digital resource are transmitted along together with the digital resource.

30. A method according to claim 21, wherein a license and the history data of the digital resource are transmitted as one entity for permitting a use of a digital resource.

31. A method according to claim 21, wherein the digital resource is a net service, which is usable by multiple execution licenses at a same time.

32. A method according to claim 21, comprising a step of modifying only certain attributes of a license request by a limited license creation unit for forming an execution license.

33. A method according to claim 21, wherein data of a received license request is verified with data of a corresponding license template in the license creation unit.

34. A system for tracking delivery channels of a digital resource and use of those by means of licensing, the system comprising
means for requesting an execution license for using a digital resource,
a license request unit for creating a license request including data of a license template of the digital resource,
attributes of a license request including history data about previous possessions of the digital resource and about a lifecycle of the digital resource,
a license creation unit for generating the requested execution license of the license request, and
a license control unit for controlling the use of the digital resource by the requested execution license.

35. A system according to claim 34, characterized in that it comprises at least one license creation unit for returning copy templates for enabling requesting an execution license for a chosen execution environment, and in addition at least one license creation unit for generating execution licenses based on copy templates.

36. A system according to claim 34, comprising the license creation unit for generating a new demonstration license and a license template including history data and data about present and previous possessions of the digital resource, and means for transmitting those along with the execution license.

37. A system according to claim 34, wherein the attributes of the license request include data for identifying the equipment requested for using the digital resource, and the history data of the digital resource.

38. A system according to claims 37, wherein the history data comprises data of a current license template, and/or data of a demonstration license of the digital resource, and/or data of a former execution license of the digital resource, and/or data of a base product of an add-on product.

39. A system according to claim 34, comprising a license creation unit, controlled by a publisher of a digital resource, for recording and/or forwarding the history data of used distribution channels and the lifecycle of a digital resource.

40. A system according to claim 34, wherein the execution license and the history data of the digital resource are transmittable with the digital resource or separately of it.

41. A system according to claim 34, wherein the digital service is a net service usable by multiple execution licenses at the same time.

42. A system according to claim 34, wherein the license request unit comprises tools for fetching history data from the license templates, demonstration licenses, and obsolete licenses of an add-on product and its base product.

43. A system according to claim 34, wherein the license creation unit is a limited license creation unit for modifying certain attributes of a license request for forming an execution license.
